(19) United States
(12) Patent Application Publication
(10) Pub. No.: US 2013/0269954 A1
(43) Pub. Date: Oct. 17, 2013

(54) Rod Suitable for Being Inserted Into a Deviated Wellbore and a Method of Manufacturing the Same

(71) Applicant: Kaj Stokkeland, Sirevag (NO)

(72) Inventor: Kaj Stokkeland, Sirevag (NO)

(73) Assignee: ZIEBEL AS, Stavanger (NO)

(21) Appl. No.: 13/880,845

(22) PCT Filed: Nov. 15, 2011
(86) PCT No.: PCT/NO2011/000319

§ 371 Date: May 20, 2013

(30) Foreign Application Priority Data
Nov. 15, 2010 (NO) 20101603

(51) Int. Cl. E21B 17/20; F16L 11/14

(52) U.S. Cl. CPC E21B 17/20; F16L 11/14
USPC 166/381; 138/177; 427/401

(57) ABSTRACT

This application is directed toward a rod (10) suitable for being inserted into a deviated wellbore (1) in connection with completion operations or intervention operations in a production well or an injection well related to the oil and gas or geothermal industries and a method of manufacturing the same, the rod (10) including a leading portion (10L) and a trailing portion (10T), wherein the rod (10) includes an outer structure (16) capable for holding a filler material (14) influencing the density of the rod (10), and that the density of the rod (10) at the leading portion (10L) is less than the density of at least parts of the trailing portion (10T).

The present invention relates to a rod suitable for being inserted into a deviated wellbore for intervention in conduits such as well bores and a method of manufacturing the same. More particularly the invention relates to a rod suitable for being inserted into a deviated wellbore in connection with completion operations or intervention operations in a production well or injection well, such as for example, wells in the oil and gas or geothermal industries.

By the term deviated well is meant a wellbore that is not vertical and that the wellbore is intentionally drilled away from vertical. A person skilled in the art will know that a deviated well may include one or more inclined portions and one or more horizontal portions.

The rod may be inserted into the wellbore from a spool.

The rod may be used for various purposes in connection with measurements and/or specific downhole operations such as for example but not limited to opening and closing of valves, sliding sleeves and perforating operations.

It is known from the publication EP 1766180 B1 a rod suitable to be pushed into a conduit from a spool, the rod comprising a stiff outer structure to make the rod self straightening so that when pushed into the conduit, the rod has substantially no residual curvature from the spool. The rod disclosed in EP 1766180 B1 further comprising a barrier layer to protect a utility service line including an optical fibre from the stiff outer structure and to protect the optical fibre from the axial and radial stresses in the stiff outer structure.

Using a rod instead of conventional methods as e.g. coiled tubing has many advantages. The rod is much smaller and lighter, provides a faster operation and is less prone to buckling. Due to its small diameter, typically in the range of 10-20 mm, the choking effect to fluid flow in a wellbore is relatively small. This is a very important feature when the rod is used for measuring purposes in the wellbore.

The rod disclosed in EP 1766180 B1 may be inserted into a deviated well without using a so-called “well tractor”. However, the applicant of the present invention has experienced problems when pushing the rod into a well when the horizontal portion of the deviated well exceeds a certain length. Said length highly depends among other things on the friction of the bore and the so-called dogleg severity, but may be in the range of 800-1200 m. The problem arises when the frictional force between the rod and the bore exceeds the pushing force exerted on the rod, or when a leading end of the rod abuts an obstacle in the wellbore.

Publication WO 2009/014453 A2 discloses among other things a rod for use in a wellbore, where the rod has a density of less than 1.5 kg/dm³ that is alleged to give it an approximately neutral buoyancy in the well. This will result in reduced frictional forces between the outside surface of the rod and the internal wall of the bore. However, any reduced density of the rod also reduces the gravitational force in a non-deviated, e.g. vertical, portion of the well. Thus, the gravitational force adding positively to the pushing force exerted on the rod is thereby reduced.

The invention has for its object to remedy or reduce at least one of the drawbacks of the prior art or at least provide a useful alternative to the prior art.

The object is achieved through features which are specified in the description below and in the claims that follow.

According to a first aspect of the present invention there is provided a rod suitable for being inserted into a deviated wellbore in connection with completion operations or intervention operations in a production well or an injection well related to energy recovery, the rod including a leading portion and a trailing portion, wherein the rod comprises an outer structure capable for holding a filler material influencing the density of the rod, and that the density of the rod at the leading portion is less than the density of at least parts of the trailing portion.

This has the effect that the frictional forces between the outside of the rod and the wall of the deviated portion of the conduit may be reduced while at the same time the gravitational force from a trailing portion of the rod being in a non-deviated portion of the conduit facilitates insertion of the rod.

In one embodiment, the leading portion of the rod has a density corresponding substantially to the density of the fluid present in the conduit. For a hydrocarbon producing well the density of the leading portion of the rod may for example, but not limited to, be in the range of 0.6-1.0 kg/dm³. In one embodiment of the present invention the rod is a continuous rod manufactured in one piece.

In another embodiment the rod is made up of two or more rod-elements connected to each other in series by a connecting means.

The rod may have a gradient density, or the rod may have a density that increases stepwise from the leading portion to the trailing portion. This also applies to said two or more rod elements. However, one or more of the rod elements may have a constant density along its length and some of the rod elements may have equal density.

Preferably, the outer structure of the rod makes the rod self straightening, so that when inserted into the conduit, the rod has substantially no residual curvature from a spool holding the rod when not inserted into the wellbore.

The rod may further comprise a barrier layer for protecting a utility service line running along the length of the rod, the barrier layer being substantially embedded in the filler material. The utility service line may comprise one of or a combination of an optical fibre, an electrical data line, an electrical power line or a hydraulic power line. Alternatively, some of or all of the electrical lines, the optical fibres and the hydraulic power line may be embedded in the filler material. The rod may then be provided without said barrier layer.

Each of said optical fibre, electrical data line, electrical power line or hydraulic power line may comprise a plurality of fibres/lines.

In one embodiment of the present invention the density of the leading portion of the rod is adapted to the density of a liquid in the wellbore in such a way that the leading portion of the rod has a density such that the frictional forces between the rod and the wellbore tends towards zero. Ideally, the rod being in the horizontal portion of the deviated well should be in neutral buoyancy with the liquid in the well or floating on the liquid.

The outer structure of the rod may be further provided with a protective material to provide extra wear resistance to the rod.

In a second aspect of the present invention there is provided a method of manufacturing a rod according to the first aspect of the invention, wherein the method comprising the steps of:
a) conducting one or a mixture of two or more filler materials into a forming means;
b) forming the filler material having a desired density such that the filler material constitutes at least a portion of a core of a the rod;
c) applying a structure around the core, the structure forming a stiff outer structure of the rod; and
d) repeating steps a-c continually or at intervals so that the rod achieves the desired density along its length.

There is also described an apparatus for application of a material for protecting the surface of a rod suitable for being inserted into a deviated wellbore in connection with completion operations or intervention operations in a production well or an injection well, the apparatus comprising:
an application chamber having a first opening and a second opening for leading the rod through the chamber;
a receptacle holding a surface protection material, the receptacle being in fluid communication with the application chamber; the apparatus being arranged above a surface intervention BOP (Blow Out Preventer).

In one embodiment the apparatus is arranged below a stuffing box. Alternatively, the apparatus may be arranged above a stuffing box.

There is also described a method for protecting a surface of a rod suitable for being inserted into a deviated wellbore in connection with completion operations or intervention operations in a production well or an injection well, the method comprising the steps of: arranging an application apparatus comprising a surface protection material above a surface intervention BOP; leading the rod through the apparatus when commencing the insertion of rod into the wellbore.

A third aspect of the present invention regards use of a variable density rod according to the first aspect of the invention to facilitate insertion thereof in a deviated wellbore in a production well or injection well, such as for example, wells in the oil and gas or geothermal industries.

In what follows is described an example of a preferred embodiment which is visualized in the accompanying drawings, in which:

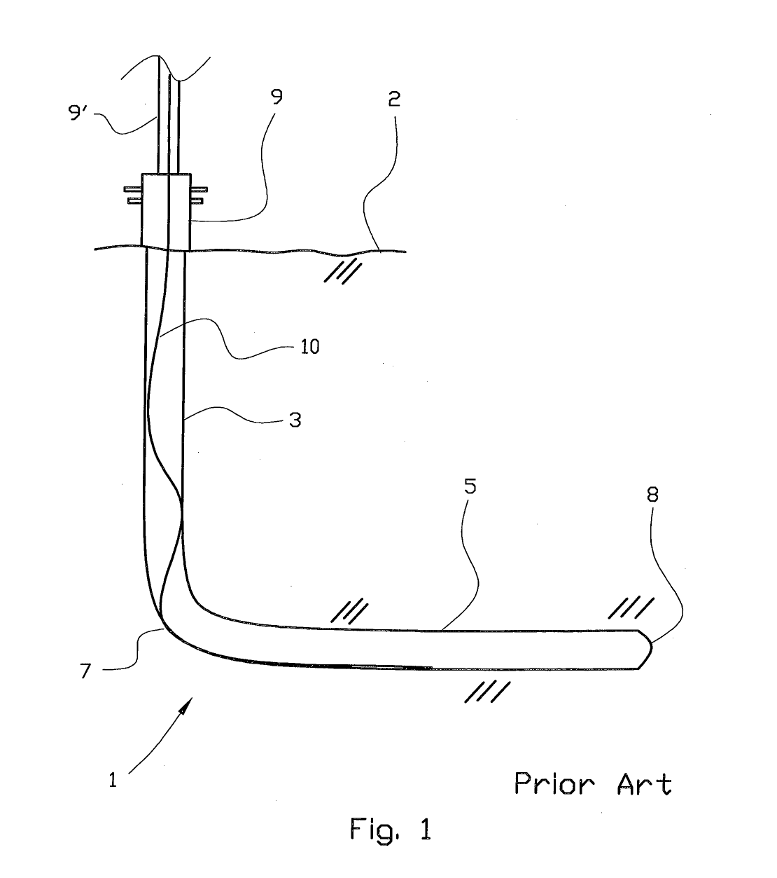

FIG. 1 shows in schematic form a prior art rod inserted in a deviated well;

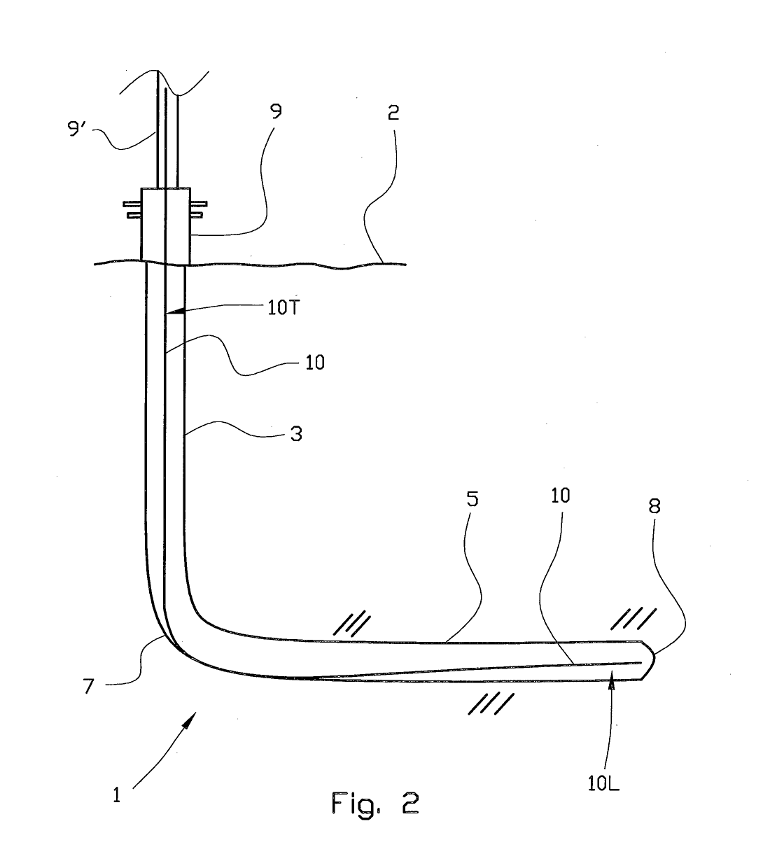

FIG. 2 shows in schematic form a rod according to a first embodiment of the present invention inserted in the well shown in FIG. 1;

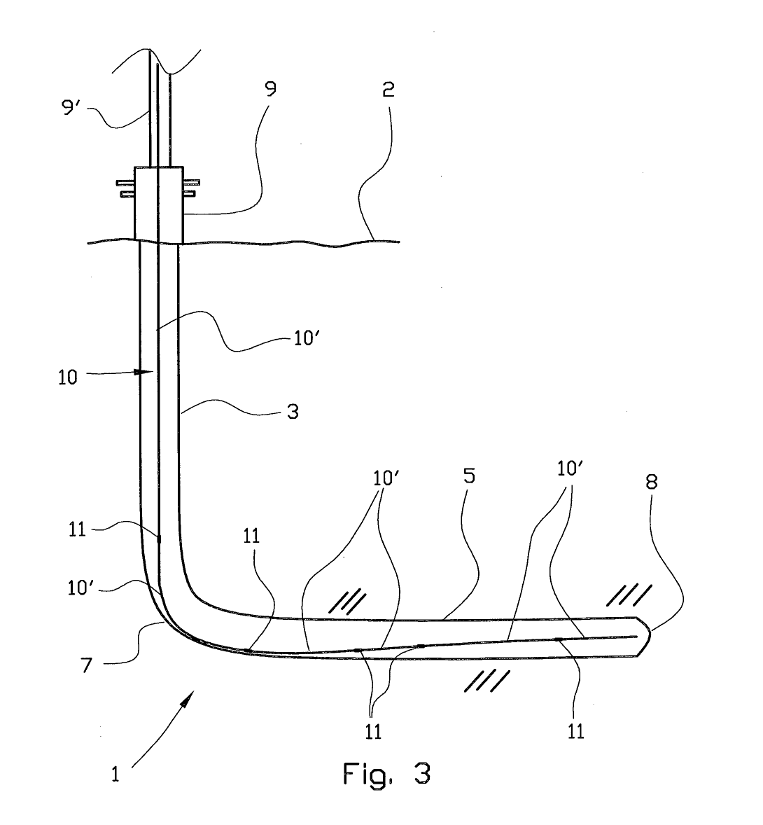

FIG. 3 shows in schematic form a rod according to a second embodiment of the present invention inserted in the well shown in FIG. 1;

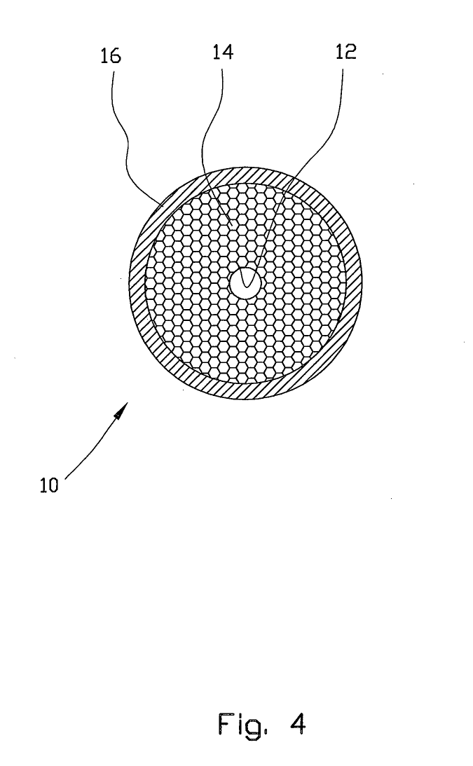

FIG. 4 shows a cross sectional view of a rod according to the present invention;

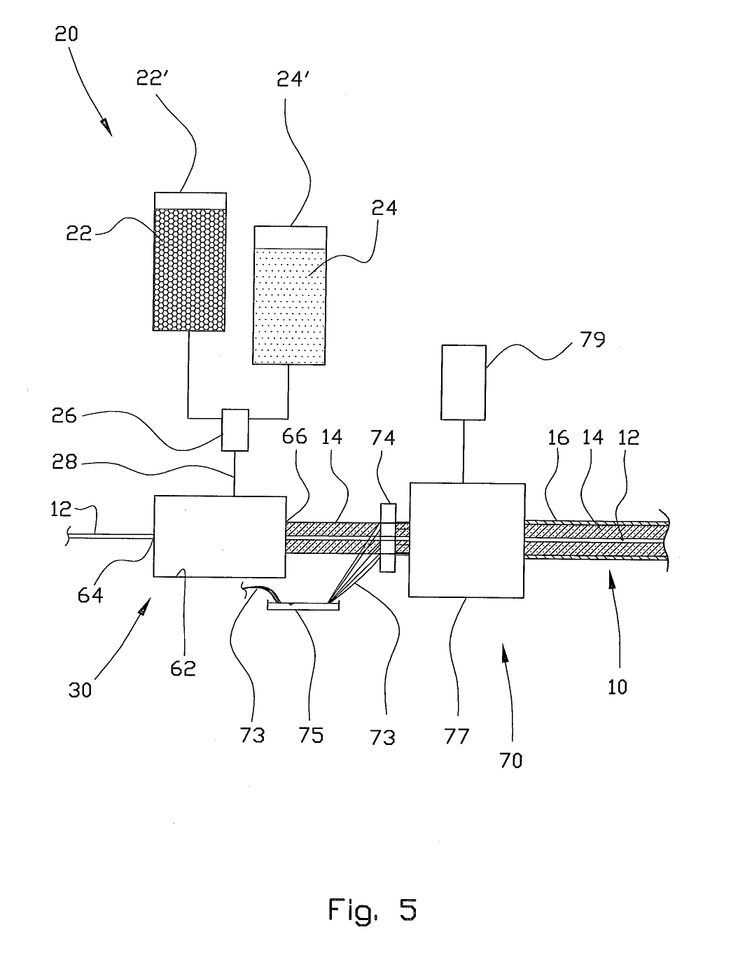

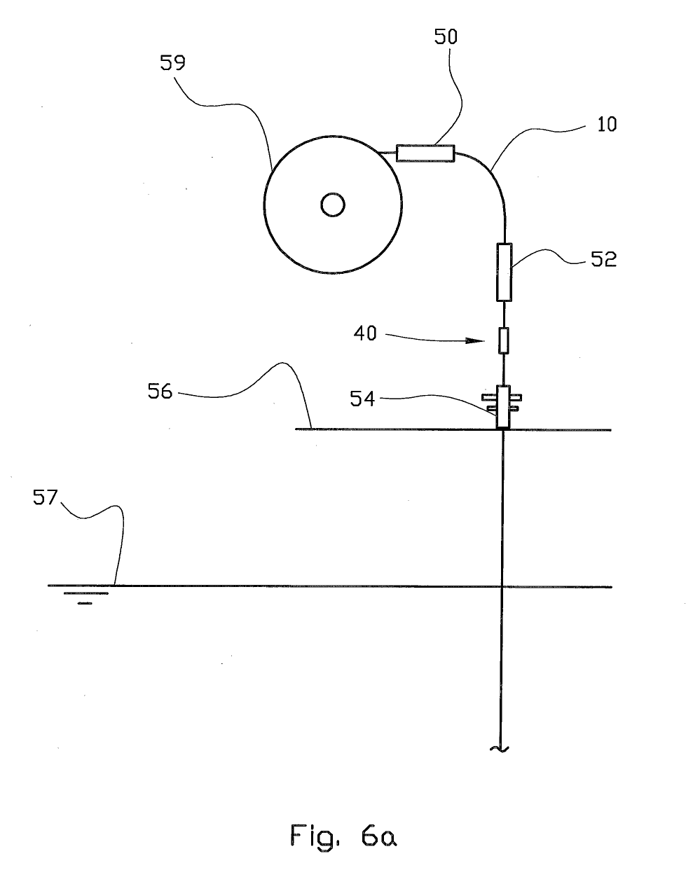

FIG. 5 shows a principle view of an apparatus for manufacturing the rod shown in FIG. 4;

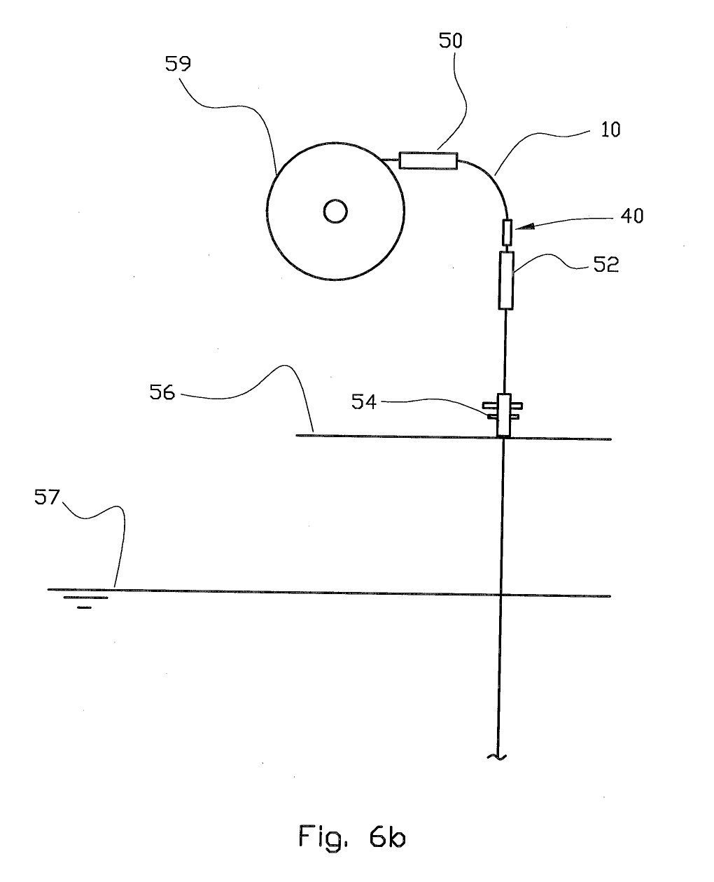

FIGS. 6a and 6b show principle sketches of an apparatus for application of a material for protecting the surface of the rod; and

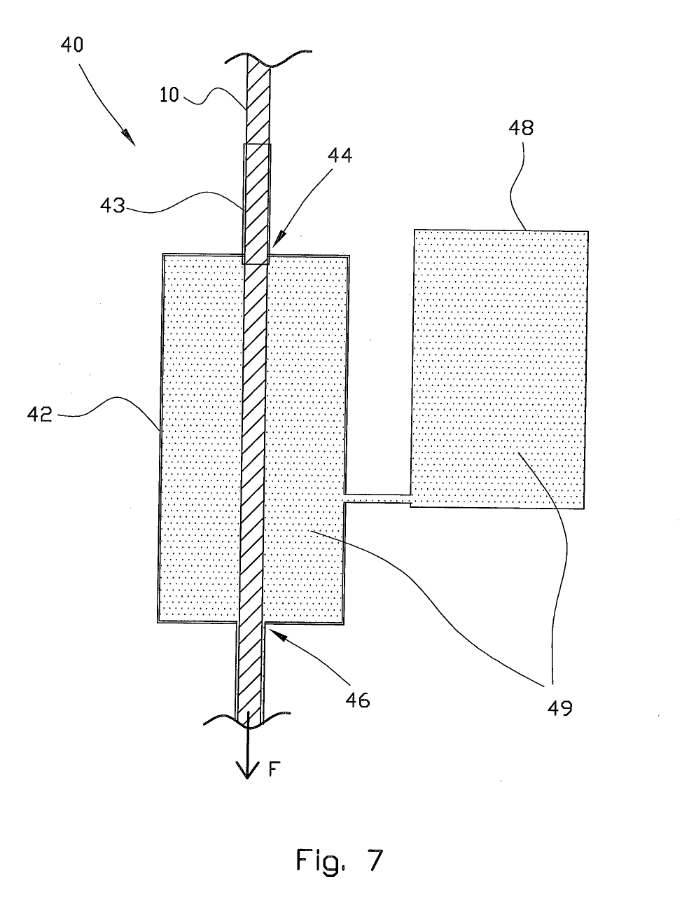

FIG. 7 shows in larger scale a cross sectional view of the surface cover apparatus 40 shown in FIGS. 6a and 6b.

In the figures, like or corresponding parts may be indicated by the same reference numerals.

Positional indications such as upper, lower, left, right refer to the position shown in the figures.

The mutual dimensions of elements shown in the figures are distorted. For example, mutual dimensions between the diameter of the wellbore and the length of the wellbore are very much distorted.

In the figures the reference numeral 1 indicates a wellbore having a vertical portion 3 and a horizontal portion 5. Although a horizontal portion 5 is shown, it should be noted that the wellbore 1 may be inclined upwards or downwards from the heel 7 of the wellbore 1.

The length of the vertical portion 3 of the wellbore 1 may for example be 3000 m, and the length of the horizontal portion 5 of the wellbore 1 may for example be 3000 m.

A wellhead 9 is arranged at a seabed 2. The wellhead 9 comprises a BOP as will be known to a person skilled in the art. A riser 9′ extends from the wellhead 9 to for example a rig (not shown) at the surface.

FIG. 1 shows a rod 10 according to prior art extending into a horizontal portion 5 of the wellbore 1. The rod 10 may for example be the rod disclosed in EP 1766180 B1 which has a constant density along its length. Although not shown, it should be understood that the rod 10 extends through the riser 9′ to said rig.

The density of the rod 10 is higher than the density of a liquid in the wellbore 1 surrounding the rod 10. The liquid may for example be oil.

In FIG. 1 the rod 10 has been inserted about halfway into the horizontal portion 5 of the wellbore 1. Due to friction between the wall of the wellbore 1 and the rod 10, the pushing force exerted on the rod 10 from an inserting apparatus arranged on for example said rig, has exceeded the compression capacity of the rod 10. This has resulted in the rod becoming “helical” in the vertical portion 3 of the wellbore 1. Such a situation further increases the frictional forces between the rod 10 and the wellbore 1.

The problems shown in FIG. 1 is even larger when the rod is made up of e.g. a wireline or slickline instead of the rod disclosed in EP 1766180. A so-called well tractor arranged for pulling the rod is therefore normally required in a horizontal well.

However, a person skilled in the art will know that using well tractors may represent considerable drawbacks with regards to its very limited speed, limited reach and considerable problems if the well tractor gets stuck in the wellbore and so-called fishing operations must be carried out.

FIG. 2 shows a rod 10 according to the present invention inserted into a wellbore 1 identical to the wellbore 1 shown in FIG. 1. The leading portion 10L of the rod 10 is near a toe portion 8 of the wellbore 1. The trailing portion 10T is located in the vertical portion 3 of the wellbore 1.

The rod in FIG. 2 is made in one piece.

The rod 10 has a gradient density where the portion of the rod 10 being adjacent the toe portion 8 of the wellbore 1 has the lowest density and the portion of the rod 10 being in a vertical portion 3, e.g. adjacent the wellhead 9, has the highest density. The gradient between the leading portion 10L and the trailing portion 10T may for example, but not limited to, be ten, meaning that the density of the rod 10 at e.g. the wellhead 9 is ten times the density of the rod 10 at the toe portion 8.

The density of the rod 10 at the toe portion 8 is such that the rod 10 being in a substantial neutral buoyancy in a length of the horizontal portion 5 of the wellbore 1. As the rod 10 “floats” in the liquid present in the wellbore 1, there is substantially no friction between the rod 10 and the wall of the wellbore 1.

A person skilled in the art will appreciate that a friction force between two elements depends on the coefficient of kinetic friction and the normal force between the elements. Thus, reducing the normal force between the rod 10 and the wall of the wellbore 1 by means of reducing the density of the rod 10 will reduce the force required to insert the rod 10 into the horizontal portion 5 of the wellbore 1.

As opposed to the desire of having a low density rod 10 in the horizontal portion 5 of the well 1 in order to reduce the friction between the rod 10 and the wall of the wellbore 1, it is an advantage if the rod 10 has a relatively high density in the vertical portion 3 of the wellbore 1. This is due to the fact that a gravitational force acting downward in the vertical portion 3 of the wellbore 1 will facilitate insertion of the rod 10 into the wellbore 1.

It will be understood that during commencement of the insertion of the rod 10 into the wellbore 1, the leading portion 10L of the rod 10 shown in FIG. 2 will, due to its neutral buoyancy, not provide a downward force facilitating the insertion of the rod into the vertical portion 3. However, until the rod 10 abuts a heel 7 of the wellbore 1 there is substantially no frictional forces between the rod 10 and the wall of the wellbore 1.

FIG. 3 shows an alternative embodiment of the rod 10 according to the present invention.

In FIG. 3 the rod 10 is made up of a plurality of rod-elements 10′ (six is shown) connected to each other in series by connecting means 11. The length of the rod elements 10′ varies in the embodiments shown.

The connecting means 11 may be any known means suitable for providing a connection designed to stand the compression forces and tension forces that may be exerted on the rod 10 during operation.

The connection means 11 may for example, but not limited to, be made up of a threaded pin and box connection. The pin may be provided in one of the rods, while the box may be provided in the other of the rods. Alternatively each of the rod ends to be connected may be provided with a pin. The pins are connected by means of a sleeve providing the box.

Advantageously the outer diameter of the connection means 11 corresponds to the outer diameter of the rod elements 10′, but might alternatively be larger or smaller than the diameter of the rod 10. For illustrative purposes the connecting means 11 are shown with a larger diameter than that of the rod elements 10′.

Each single rod element 10′ may have a constant density throughout its length. However, one or more rod elements 10′ in the horizontal portion 5 of the wellbore 1 has a lower density than one or more of the rod elements 10′ located in the vertical portion 3 of the wellbore 1.

In the embodiment shown in FIG. 3 the rod element 10′ facing the toe 8 of the wellbore 1 has the lowest density. Each successive rod element 10′ has an increasing density in the direction of the wellhead 9 such that the rod element 10′ at the wellhead 9 has the highest density. In this embodiment the rod 10 has a “stepwise” gradient density, the steps corresponding to the length of each rod element 10′.

In an alternative to the above “stepwise” gradient density, each rod element 10′ may be provided with a gradient density between its two ends.

A rod 10 made up of a plurality of rod elements 10′ connected to each other in series may be tailored with respect to desired density properties along its length.

FIG. 4 shows in a larger scale a cross sectional view of a rod 10 according to the present invention having the same intended use as the rod disclosed in EP 1766180 B1. The rod 10 is therefore provided with an internal barrier element 12 in the form of a tube intended for housing a utility service line (not shown). The utility service line may one of or a combination of an optical fibre, an electrical data line, an electrical power line and/or a fluid power line. The fluid power line may be a hydraulic power line.

In the embodiment shown in FIG. 4 the barrier element 12 is arranged substantially coaxially with the longitudinal axis of the rod 10. However, the barrier element 12 may alternatively be provided non-coaxially with the longitudinal axis of the rod 10.

A rod filler material 14 used for controlling the density of the rod 10 is provided between the barrier layer 12 and a stiff outer structure 16.

FIG. 5 shows a principle view of an apparatus 20 that might be used for manufacturing a rod 10 according to the embodiment shown in FIG. 4.

The apparatus 20 includes a first reservoir 22′ containing a first filler material 22 and a second reservoir 24′ containing a second filler material 24. The first filler material 22 may be a material of very low density, e.g. foam with a density of 10 kg/m³. The second filler material 24 may be a material with a relatively high density, e.g. metal particles with a density of 5000-10000 kg/m³, depending of particle sizes and type of metal(s).

The apparatus 20 may include more than the two reservoirs 22′, 24′ shown for containing filler materials with various densities and material properties.

The filler materials 22, 24 may be mixed in a mixing station 26 in such a way that filler material of desired density are conveyed in a conduit 28 from the mixing station 26 and into forming means 30 forming the filler material 14 or the “core” of the rod 10.

In one embodiment (not shown) the filler material 14 of the rod element 10′ is constituted by a gas. The rod element 10′ is then manufactured as a tube being provided with a seal at both ends.

The forming means 30 comprises a filler material application chamber 62 having a first opening 64 and a second opening 66. The sizes of the openings 64, 66 are adapted to the size of the barrier layer 12 and the desired thickness of the filler materials respectively when applied to the barrier layer 12 as will be explained below.

The first opening 64 has a dimension corresponding substantially to the dimension of the barrier layer 12 in such a way that a clearance between the barrier layer 12 and the wall of the first opening 64 is minimal.

The second opening 66 has a dimension corresponding to the desired diameter of the filler material 14 of the complete rod 10 so that when fed through the forming means 30 the “core” of the rod 10 will be formed. This “core” will in the following be denoted rod filler material 14 which is made from one of or a mixture of the filler materials 22, 24.

At least one of the filler materials 22, 24 in the reservoirs 22′, 24′ must be able to cure after application. Alternatively, a curing agent must be provided from a third reservoir (not shown). Thus, depending on the type of filler material used, the forming means 30 may be provided with a curing means (not shown). The curing may be provided by applying for example a chemical and/or by a radiation means suitable for curing the filler material(s) 22, 24 in the filler material application chamber 62.

The utility service line (not shown) may or may not be provided inside the barrier element 12 during the manufacturing process.

The rod filler material 14 is fed into a protective cover application apparatus 70 for providing the stiff outer structure 16 of the rod 10. Such an apparatus 70 will be known to a person skilled in the art. Therefore only a brief description will be given below.

In a preferred embodiment the stiff outer structure 16 is made of a composite material such as carbon fibres 73 provided with a resin from a resin bath 75. The carbon fibres 73 are distributed around the rod filler material 14 by means of a fibre distributor 74.

The rod filler material 14 and the carbon fibres 73 are conveyed through a heat die 77 by means of a pull machine (not shown) arranged downstream of the heat die 77. In the heat die 77 a bonding agent is applied from a bonding agent container 79.

The density of the rod 10 depends on the mixing ratios between the first filler material 22 and the second filler material 24.

The mixing station 26 may be controlled by a control means (not shown) including valves (not shown) such that a desired density gradient is achieved for the rod 10, or rod elements 10′ with desired density are achieved.

FIG. 6a and FIG. 6b show principle sketches of an apparatus 40 for application of a material for protecting the surface of the rod 10. The apparatus 40 will in the following be denoted surface cover apparatus 40.

The purpose of the surface cover apparatus 40 is to cover the rod 10 with a material that primarily provides an extra wear resistance to the rod 10. The material used may for example be a polymeric material like polyurethane or other suitable materials.

In FIGS. 6a and 6b the surface cover apparatus 40 is arranged in connection with an injector 50 and a stuffing box 52 arranged above an intervention BOP 54 located on a surface vessel 56 indicated by a line only. The vessel 56 floats on a sea 57. The injector 50, stuffing box 52 and intervention BOP 54 will be known to a person skilled in the art and thus not described in any further details.

The rod 10 is spooled into a wellbore from a spool 59. The wellbore may be the wellbore 1 shown in FIGS. 1-3.

In FIG. 6a the surface cover apparatus 40 is arranged below the stuffing box 52, while in FIG. 6b the surface cover apparatus 40 is arranged above the stuffing box 52.

FIG. 7 shows in larger scale a cross sectional view of the surface cover apparatus 40 shown in FIGS. 6a and 6b.

The surface cover apparatus 40 comprises an application chamber 42 having a first opening 44 and a second opening 46. The sizes of the openings 44, 46 are adapted to the size of the rod 10 with and without the surface cover as will be explained below.

The application chamber 42 is in fluid communication with a receptacle 48 holding a surface protection material 49. The surface protection material 49 may be urged into the application chamber by a pressure means (not shown) such that the application chamber 42 is filled with surface protection material 49.

The first opening 44 has a dimension corresponding substantially to the dimension of the rod 10 in such a way that a clearance between the rod 10 and the wall of the first opening 44 is minimal.

The second opening 46 has a dimension corresponding to the dimension of the rod 10 plus twice the desired thickness of the surface protection material 49 on the rod 10.

When fed through the surface cover apparatus 40 in the direction indicated by arrow F, the surface of the rod 10 will be covered by surface protection material 49.

In order to provide a uniform thickness of the surface protection material 49, the surface protection apparatus 40 may be provided with guiding means 43 for arranging the rod 10 coaxially with the openings 44, 46. In FIG. 7 the guiding means 49 is constituted by a sleeve extending upwardly from the first opening 44.

1. A rod (10) suitable for being inserted into a deviated wellbore (1) in connection with completion operations or intervention operations in a production well or injection well related to the oil and gas or geothermal industries, the rod (10) comprising:
a leading portion (10L) and a trailing portion (10T):
an outer structure (16) enclosing a rod filler material (14) influencing the density of the rod (10); and
the density of the rod (10) at the leading portion (10L) is less than a density of at least parts of the trailing portion (10T).

2. The rod according to claim 1, wherein the rod (10) is a continuous rod manufactured in one piece.

3. The rod according to claim 1, wherein the rod (10) is made up of two or more rod elements (10′) connected to each other in series by a connecting means (11).

4. The rod according to claim 1, wherein the rod (10) has a gradient density.

5. The rod according to claim 1, wherein the rod (10) has a density that increases stepwise from the leading portion (10L) to the trailing portion (10T).

6. The rod according to claim 3 wherein each individual rod element (10′) has a substantially constant density throughout its length.

7. The rod according to claim 1, wherein the outer structure (16) of the rod (10) makes the rod (10) self straightening, so that when inserted into the wellbore (1), the rod (10) has substantially no residual curvature from a spool (41) holding the rod (10) when stored.

8. The rod according to claim 1, wherein the filler material has a density ranging from 10 kg/m³ to 10000 kg/m³.

9. The rod according to claim 1, wherein the rod (10) further comprising a barrier layer (12) for protecting a utility service line running along the length of the rod, the barrier layer (12) being substantially embedded in the filler material (14).

10. The rod according to claim 9, wherein the barrier layer (12) is arranged substantially coaxially with the longitudinal axis of the rod (10).

11. The rod according to claim 9, wherein the utility service line comprising one of or a combination of members selected from the group consisting of: an optical fibre, an electrical data line, an electrical power line or a hydraulic power line.

12. The rod according to claim 1, wherein the density of the leading portion (10L) of the rod (10) is adapted to a density of a liquid in the wellbore (1) in such a way that the leading portion (10L) of the rod (10) has a density such that frictional forces between the rod and the wellbore tend towards zero.

13. The rod according to claim 1, wherein the rod (10) further comprising one of or a combination of members selected from the group consisting of: an optical fibre, an electrical data line, an electrical power line or a hydraulic power line, wherein some of or all of said electrical lines, the optical fibre and the hydraulic power line are embedded in the filler material.

14. The rod according to claim 1, wherein the outer structure (16) of the rod (10) is further provided with a protective material (49) to provide extra wear resistance to the rod (10).

15. The rod according to claim 14, wherein the protective material (49) is a polymeric material.

16. A method of manufacturing a rod (10) suitable for being inserted into a deviated wellbore, the method comprising the steps of:
a) conducting one of or a mixture of two or more filler materials (22, 24) into a forming means (30);
b) forming the filler material having a desired density such that the filler material constitutes at least a portion of a core of a rod (10);
c) applying a structure (16) around the core, the structure forming a stiff outer structure of the rod (10); and
d) repeating steps a-c continually or at intervals so that the rod (10) achieves the desired density along its length.

17. Use of a variable density rod according to claim 1 to facilitate insertion thereof in a deviated wellbore (1) in a production well or an injection well related to the oil and gas or geothermal industries.

18. The rod according to claim 6 wherein the filler material is constituted by a gas.
